(19) United States
(12) Patent Application Publication
(10) Pub. No.: US 2014/0369846 A1
(43) Pub. Date: Dec. 18, 2014

(54) EROSION RESISTANT IMPELLER VANE MADE OF METALLIC LAMINATE

(71) Applicant: Tomas Berglund, Falun (SE)

(72) Inventor: Tomas Berglund, Falun (SE)

(73) Assignee: SANDVIK INTELLECTUAL PROPERTY AB, SANDVIKEN (SE)

(21) Appl. No.: 14/344,970

(22) PCT Filed: Sep. 14, 2012
(86) PCT No.: PCT/EP2012/068076

§ 371 Date: Mar. 14, 2014

(30) Foreign Application Priority Data
Sep. 15, 2011 (EP) 11181465.3

(51) Int. Cl. F04D 29/22; B23K 20/00; B22F 5/00; F04D 29/24

(52) U.S. Cl. CPC F04D 29/2294; F04D 29/24; B23K 20/002; B22F 5/009; F05D 2230/23; F05D 2230/42
USPC 416/224; 228/182; 419/8

(57) ABSTRACT

An impeller vane includes at least a first metallic core material and at least a first wear resistant material, wherein the hardness of the at least first wear resistant material exceeds the hardness of the at least first metallic core material. The impeller vane consists of a plurality of layers of the at least first metallic core material and the at least first wear resistant material, wherein the layers extend from a leading edge of the impeller vane to the trailing edge of the impeller vane and are arranged alternatingly throughout the cross section of the impeller vane. An impeller includes at least one of the above impeller vanes. The invention also relates to methods for manufacturing an impeller vane and an impeller having such.

### TECHNICAL FIELD

The present invention relates to an impeller vane according to the preamble of claim 1. The present invention also relates to an impeller comprising at least one said impeller vane.

Furthermore, the present invention also relates to a method for manufacturing said impeller vane and to a method for manufacturing an impeller comprising at least one said impeller vane.

### BACKGROUND

The vanes of impellers that are used in various types of pumping devices are subjected to wear from particles suspended in the liquid or gas that is pumped. Especially the vanes of impellers in slurry pumps are subjected to extensive wear. In operation, an impeller vane may be used until approximately 50 percent of the length of the impeller has been consumed. Thereafter the impeller vane must be replaced.

In order to increase wear resistance, conventional, wear resistant, impeller vanes typically consist of a steel core that is selected so that the impeller vane is provided with desired mechanical properties. The core is coated with a cladding of a hard, wear resistant material. The leading edge of the impeller vane is subjected the heaviest wear and is therefore typically provided with a thicker cladding than the rest of the impeller. US2010/0272563 A1 shows a conventional impeller vane.

However, although the outer cladding provides some wear resistance and initially prolongs the life time of the impeller vane, the conventional impeller vanes still suffers from relatively short life time in extreme conditions.

FIGS. 1a-1d shows the general wear mechanism of a conventional impeller vane having a steel core and an outer wear resistant cladding. FIG. 1a shows an unused impeller vane in cross-section. After some use, see FIG. 1b, the leading edge of the impeller vane is significantly worn. When the hard coating of the impeller vane is completely worn down, the soft steel core is uncovered and wear of the impeller vane accelerates, see FIG. 1c. As the steel core deteriorates, the outer hard and brittle cladding loses its support and start to crack and fall of in large pieces, see FIG. 1d. This causes the wear of the impeller vane to accelerate even more. Hence, in conventional impeller vanes, the wear rate is initially rather slow but accelerates significantly over time so that the total life time of the impeller vane is short.

Hence, it is an object of the present invention to achieve an impeller vane that has increased life time.

### SUMMARY

According to the present invention this above-mentioned object is achieved by providing an impeller vane having a leading edge and a trailing edge wherein said impeller vane comprises at least a first metallic core material and at least a first wear resistant material, wherein the hardness of said at least first wear resistant material exceeds the hardness of said at least first metallic core material, characterized in that said impeller vane consists of a plurality of layers of said at least first metallic core material and of said at least first wear resistant material, wherein said layers extend from the leading edge to the trailing edge of the impeller vane and are arranged alternating throughout the cross section of the impeller vane.

In the impeller vane according to the present invention, the laminate design of alternating hard, wear resistant layers and softer metallic core layers extending over the length of the impeller vane provides for the same wear resistance over the entire length of the impeller vane and hence a constant wear rate of the impeller vane. This increases the total life time of the impeller vane in comparison with conventional impeller vanes in which the major life time limiting wear occurs at the tip of the leading edge of the impeller vane.

Another advantage of the impeller vane according to the present invention is that it has high resistance against impact with larger objects since the ductile layers of said at least first metallic core material prevents crack growth between the layers of the impeller vane.

The mechanical properties, i.e. the strength and toughness of the impeller vane according to the present invention, are determined by the combination of the properties of the first metallic core material and the first wear resistant material. These materials may be selected by the skilled person and are dependent of the desired mechanical properties of the impeller vane and the conditions in which the impeller vane is used. However, the hardness of the wear resistant material should be higher than the hardness of the first metallic material and the ductility and/or toughness of the first metallic core material should be higher than the ductility and/or toughness of the wear resistant layer. Preferably, the first metallic core material is less brittle and has a higher impact strength than the wear resistant material.

The wear rate of the impeller vane according to the present invention is generally determined by the properties of the wear resistant layer and the thickness of the metallic core layers and the wear resistant layers in the laminate structure. Generally, an impeller vane with a high number of thin layers provides a better wear resistance, i.e. a lower wear rate, than an impeller vane with few thick layers. On the other hand, an impeller vane having a large number of thin layers implies higher production costs, therefore it is preferred to adopt the number and the thickness of the layers in relation to the conditions the impeller vane is used in. These conditions are typically flow rate, particle size, particle hardness and number of particles in the liquid or slurry. It is preferred to have many thin layers of the first metallic core material if it the impeller vane is used in conditions with high flow rates and/or small size particles.

By the term “plurality of layers” is meant that the impeller vane comprises at least 5 alternating layers.

The phrase “first metallic core material” has been selected in order to clarify that this is a material of different properties than the material that is denominated “first wear resistant material”

Preferably, the layers of said at least first metallic core material have a thickness of 5 mm or less, preferably 3 mm or less, more preferred 2 mm or less.

Preferably, the layers of said at least first wear resistant material have a thickness of 15 mm or less, preferably 10 mm or less, more preferred 2 mm or less.

Preferably, said impeller vane consists of at least 5 layers, preferably at least 20 layers, more preferred at least 70 layers.

The impeller vane according to the present invention may also comprise layers of further metallic core materials and/or layers of further wear resistant materials.

Said at least first metallic core material is selected from the group consisting of nickel-base alloys, low carbon cobalt-base alloys and iron-base alloys. Low carbon cobalt-base alloys are referred to as such alloys having a carbon content of 0.5 wt % or less.

Said at least first wear resistant material is selected from the group consisting of cemented carbide, high carbon cobalt-base alloys and metal matrix composite. High carbon cobalt-base alloys are referred to as such alloys having a carbon content of 1.0 wt % or more.

The present invention further relates to an impeller comprising at least one impeller vane as disclosed hereinabove or hereinafter.

The present invention further relates to a method for manufacturing an inventive impeller vane as disclosed hereinabove or hereinafter, said method is characterised in that it comprises the steps of:
i) alternating arranging a plurality of layers of at least a first metallic material and a at least a first wear resistant material;
ii) forming said layers to an impeller vane preform;
iii) subjecting said impeller vane preform to a “High Isostatic Pressure”-process (HIP) for a predetermined time at a predetermined pressure and predetermined temperature so that the layers of said at least first metallic material and said at least first wear resistant material bond metallurgically;
   wherein an impeller vane as disclosed hereinabove or hereinafter is obtained. Said HIP process takes place without the formation of any melt phases.

Furthermore, the present invention relates to a method for manufacturing an impeller comprising an impeller vane as disclosed hereinabove or hereinafter, characterized in that said method comprises the steps of
alternating arranging a plurality of layers of at least a first metallic material and at least a first wear resistant material;
forming said layers to at least one impeller vane preform;
providing a front impeller disc and a rear impeller disc;
metallurgically bonding, in a High Isostatic Pressure-process (HIP), the layers of said at least first metallic core material and said at first wear resistant material of said at least one impeller vane preform to each other and to the front impeller disc and a rear impeller disc;
   wherein an impeller is obtained comprising an impeller vane as disclosed hereinabove or hereinafter.

According to a first alternative, the front impeller disc and the rear impeller disc are pre-manufactured.

According to a second alternative, the method comprises the steps of:
arranging said at least one impeller vane preform in a capsule that defines the shape of the front impeller disc and a rear impeller disc;
filling said capsule with metallic powder;
metallurgically bonding, in a High Isostatic Pressure-process (HIP), said metallic powder in the capsule into an impeller front disc and an impeller rear disc and simultaneously,
metallurgically bonding said first metallic core material and said first wear resistant material of said at least one impeller vane preform to each other and to the front impeller disc and a rear impeller disc;

### BRIEF DESCRIPTION OF DRAWINGS

FIG. 1a-1d: disclose schematic cross-sectional drawings of the wear mechanism of a prior art impeller vane.

FIG. 2: discloses schematic perspective front view of an impeller comprising several inventive impeller vanes.

FIG. 3: discloses schematic perspective side view of the impeller in FIG. 2.

FIG. 4: discloses schematic front view of a cross section through the impeller in FIG. 2.

FIG. 5: discloses schematic perspective view of an impeller vane according to a first embodiment of the invention.

FIG. 6: discloses schematic drawing of a cross-section through an impeller vane according to an embodiment.

FIG. 7: disclose schematic drawing explaining the wear resistant mechanism in the impeller vane as disclosed hereinabove or hereinafter.

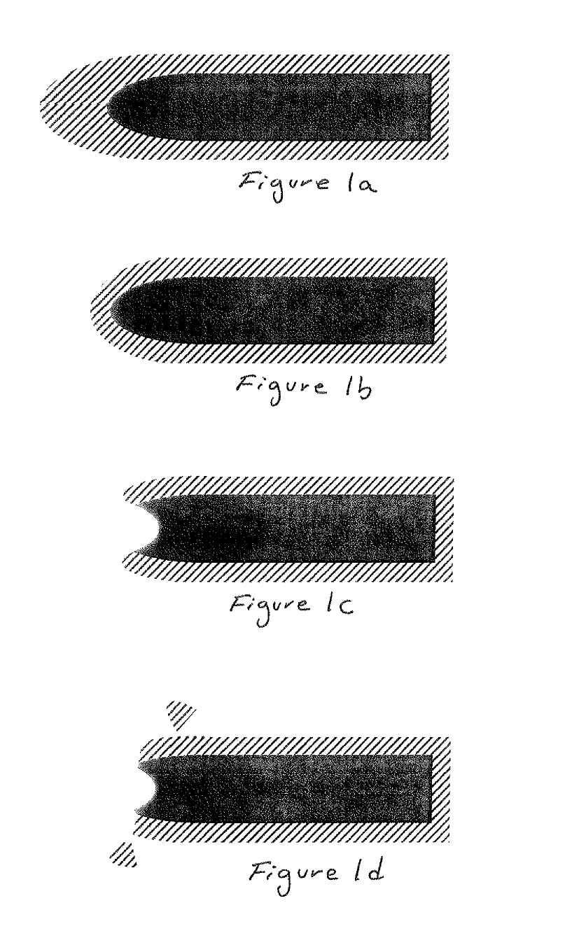

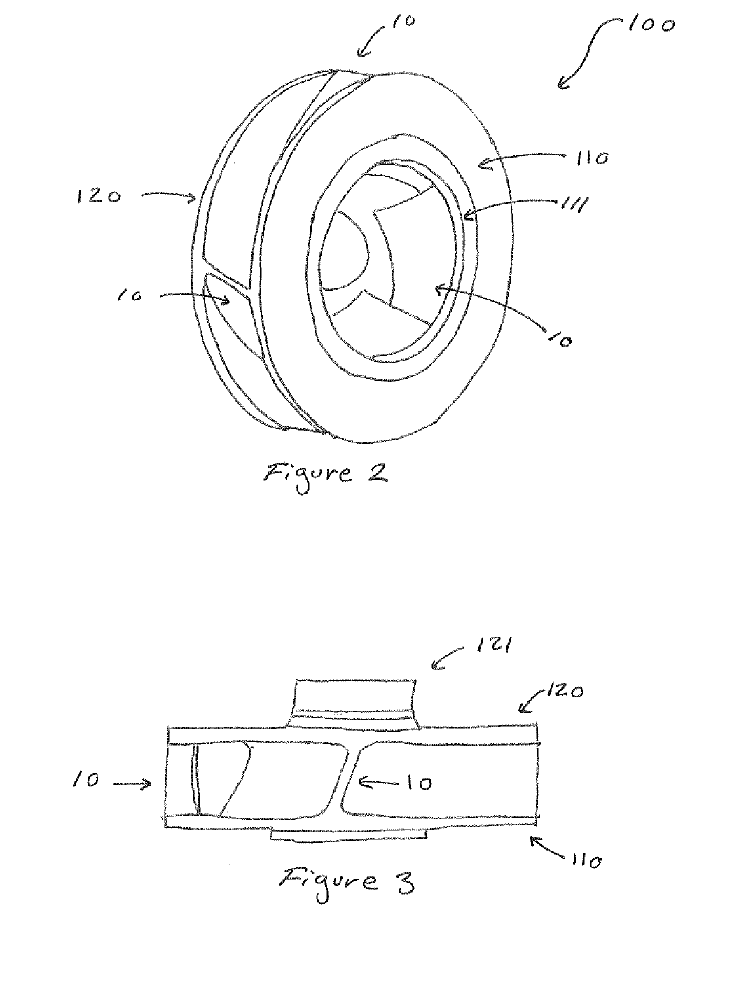

### DETAILED DESCRIPTION

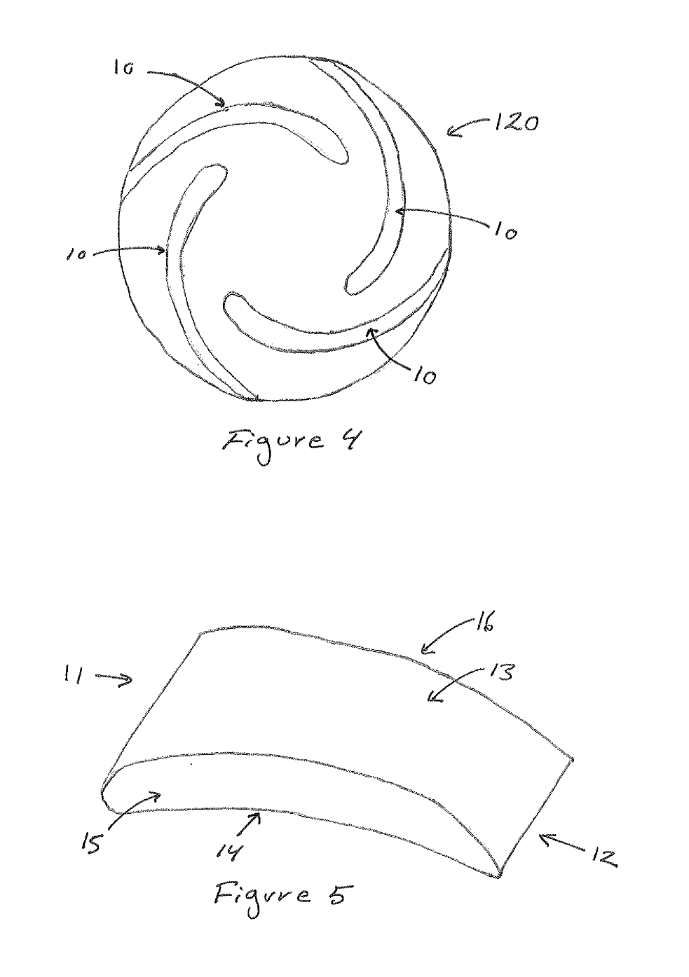

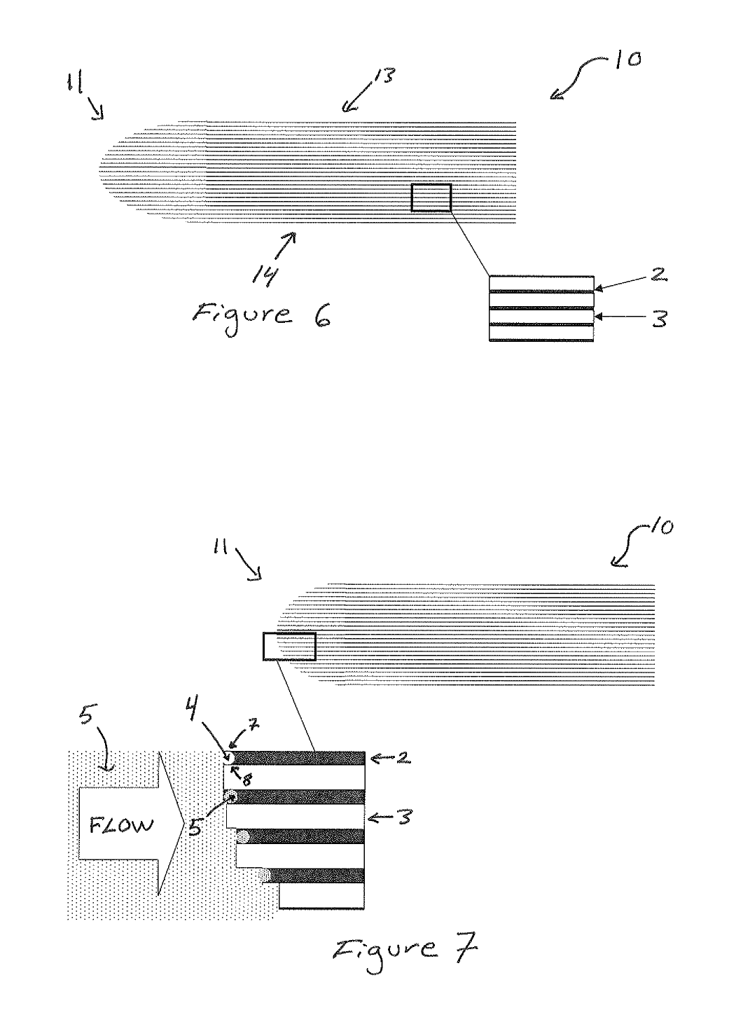

FIG. 2 shows schematically a perspective front view of an impeller 100 that may be used in any type of suitable pumping device e.g. a centrifugal pump such as a slurry pump or a submersible pump. The impeller 100 comprises a first front disc 110 and a rear disc 120 which are manufactured from steel material. The front disc 110 has a central, circular opening 111 for sucking in liquid into the impeller. The rear disc 120, see FIG. 3, has an attachment 121 for attaching the impeller to the driving shaft of a pump motor (not shown). The impeller further comprises four impeller vanes 10 which are partially shown in FIG. 2. In FIG. 4, which is a cross-section through the impeller in FIG. 2, are all four impeller vanes visible. FIG. 5 shows schematically an impeller vane 10 in detail. The impeller vane 10 has a curved form and has a forward leading edge 11 and a rear trailing edge 12. The impeller vane further comprises an upper surface 13 and a lower surface 14 which extend between the leading and trailing edges of the impeller vane. The impeller vane further comprises a first side surface 15 and a second side surface 16 which extend between the leading and trailing edges, perpendicular to the upper surface 13 and the lower surface 14. The second side surface 16 and the lower surface 14 are not visible in FIG. 5. It is obvious that the impeller vane and the impeller discs could have any other shape than the one described in FIG. 5. For example, the impeller vane could be flat or have a concave or convex shape along a longitudinal axis between its leading and trailing edges.

The impeller vane 10 is attached to the inner surfaces of the impeller front and rear discs 110, 120. This could be done in a number of different ways. The impeller vanes and impeller discs could be metallurgically bonded to each other, for example in a HIP process. The impeller vanes could also be integrated in the impeller discs during casting of the discs. The impeller vanes could also be releasable attached to the discs by fastening means such as screws. As can be seen in FIG. 4, the impeller vanes are arranged such that the leading edges 11 are close to the centre of the impeller discs and the trailing edge is close to the outer periphery of the impeller discs. However, instead of attaching the side surfaces of the impeller vane to the impeller discs, the trailing edge could be attached to a hub in the centre of the impeller discs (not shown).

FIG. 6 shows a cross-section through an impeller vane 10 according to an embodiment of the invention. For simplicity reasons, the impeller vane of FIG. 6 has been illustrated schematically in a straight form, however, it has the same curved shape as the impeller vane of FIG. 5. As can be seen in FIG. 6, see especially the closed up section, the i impeller vane as disclosed hereinabove or hereinafter consists of several layers of at least a first metallic core material 2 and several layers of at least a first wear resistant material 3.

The metallic core material 2 and the wear resistant material 3 are selected such that the metallic core material 2 has a higher ductility and/or toughness than the wear resistant material 3, whereas the hardness of the wear resistant material 3 is higher than the hardness of the metallic core material 2. It is of course possible to use layers of further metallic core materials and layers of further wear resistant materials in the impeller vane. This is advantageous for optimizing strength and wear resistance of the impeller vane.

In particular, different layers of metallic core materials may differ with regard to the composition thereof. Thereby may different mechanical and physical properties be achieved in different metallic core layers. However, the material of each such core layer still differs with regard to its physical and mechanical properties from the wear resistant layers as defined earlier. Also the layers of wear resistant material may differ with regard to the composition thereof.

For example, layers of a first metallic core material may be arranged in the upper portion of the impeller vane and layers of a second metallic core material, i.e. having a composition different from the first metallic core material, may be arranged in the lower portion of the impeller vane. Likewise, it is possible to arrange layers of a first wear resistant material in the centre of the impeller vane and layers of a second wear resistant material in the upper and lower portions of the impeller vane. However, the hardness of the both different types of wear resistant layers should be higher than the hardness of both different types of metallic core materials.

In the present embodiment, the metallic core material is carbon steel and the wear resistant material is a MMC (Metal Matrix Composite) of high-speed steel and TiC. However, other metallic core materials and the wear resistant materials may be selected for achieving desired mechanical properties and wear resistance in the impeller vane. Preferably, the metallic core materials may be selected from the group of nickel based alloys, cobalt based alloys having low carbon content and iron based alloys, such as stainless steel. These materials are suitable since they have high toughness and good resistance to corrosion. The wear resistant material may be selected from the group consisting of cemented carbide, cobalt alloys having high carbon content, MMC i.e. a composite of carbides, borides or nitrides of e.g. Tungsten (W), Titanium (Ti), Tantalum (Ta), Chromium (Cr), Vanadium (V), Molybdenum (Mo) in a metal matrix such as Nickel- (Ni—), Cobalt- (Co—), and Iron- (Fe—) based alloys.

The layers of metallic core material 2 and the layers of wear resistant material 3 are arranged alternating. Hence, a layer of metallic core material 2 is arranged on top of a layer of wear resistant material 3 and on top of the layer of metallic core material 2 is arranged a layer of wear resistant material 3 and so on.

Each layer 2, 3 extends from the first side surface 15 of the impeller vane to the second side surface 16 and from the leading edge 11 to the trailing edge 12. Each of the edges to each layer 2, 3 coincides with the leading edge, the trailing edge and the side surfaces of the impeller vane. A first bottom layer, constitutes the lower surface 14 of the impeller vane and a final top layer, constitutes the upper surface 13 of the impeller vane. Thus, the whole impeller vane consists of a laminate structure of alternating layers of wear resistant material 3 and metallic core material 2. Thus, the entire cross-section of the impeller vane consists of alternating layers.

The layers are preferably coherent layers i.e. sheets of films having a constant thickness over their entire length and width. Thereby a constant wear rate is achieved.

In order to tailor the wear resistance of the impeller vane some layers in the impeller vane could be in the form of a net or perforated sheet.

The first bottom layer and the final top layer, forming opposite outermost layers in the impeller vane, could be either a layer of wear resistant material 3 or a layer of metallic core material 2. If the uppermost and lowermost layers are of wear resistant material, high wear resistance is achieved on the outer surfaces of the impeller vane. It could however be advantageous to arrange layers of metallic core material 2 as outermost layers since these layers can be welded to the impeller discs or a HIP-capsule and hence facilitates the manufacturing process of the entire impeller.

The total number of layers in the impeller vane and the thickness of each layer can be varied. For example, it is possible that the wear resistant layers could be thicker than the layers of metallic material. The advantage thereof is that a large surface area of the leading edge of the impeller vane will be constituted by wear resistant material and hence will increase the total wear resistance of the impeller vane. The thickness of the wear resistant layers should preferably be selected so that at least 50% of the volume of the impeller vane is constituted of wear resistant material.

It is also possible to vary the thickness of specific layers over the cross-section of the impeller vane in order to optimize wear resistance and mechanical properties of the impeller vane. For example, higher flexibility could be achieved in the upper and lower portions of the impeller vane by arranging thick metallic core layers there. Higher wear resistance could be achieved in the middle portion of the impeller vane by increasing the thickness of the wear resistant layers 3 in that portion of the impeller vane.

As stated above, the total number of layers in the impeller vane as disclosed hereinabove or hereinafter as well as the thickness of the respective layers may be adopted in dependency of the conditions in the application the impeller vane should be used in. However, it has been shown that an impeller vane in which the thickness of the metallic layers is less than 5 mm provides a very long life length, i.e. low wear rate. While not wishing to be bound to any theory, the reason for this is believed to be the following: The particles in slurry are typically dispersed over a large range of different particle sizes. With reference to FIG. 7, when an impeller vane as disclosed hereinabove or hereinafter is used to pump a slurry, the layers of the metallic core material 2 in the leading edge 11 of the impeller vane are initially subjected to wear so that small, shallow, cavities 4 are formed which extend along the leading edge 11 of the impeller vane. The cavities 4 are open towards the leading edge 11 of the impeller vane and their bottoms 6 have a concave form in the layer of metallic core material 2. The walls 7, 8 of the cavities 4 are constituted by the surrounding layers of wear resistant material 3. Small particles 5 in the slurry are trapped in the shallow cavities. The small particles 5 fill the cavities 4 and form a buffer which prevents, or at least retards, further wear to the underlying metallic core material 2. The protective effect increases with decreasing thickness of the metallic layer, probably due to slower flow conditions in the cavities 4. Hence, the thickness of the metallic core material 2 should preferably be less than 3 mm, more preferred less than 2 mm.

The lowest preferred thickness is determined by what is possible to achieve in the production process and also by the desired mechanical properties of the impeller vane, since the strength of the layers decrease with decreasing thickness. Preferably, the thickness of the layer of metallic core material and the layers of wear resistant material should not be less than 0.5 mm.

It has shown that an impeller vane in which the thickness of the metallic core layers is 5 mm or less and the thickness of the wear resistant material is 15 mm or less exhibits very low wear rate and excellent mechanical properties. The total number of layers in the impeller vane depends on the thickness of the impeller vane, however, the impeller vane should comprise at least 5 layers, preferably at least 20, more preferred at least 70.

Preferably the inventive impeller vane is manufactured by using a HIP, i.e. High Isostatic Pressure, process.

According to one alternative, the impeller vane is manufactured by alternating arranging layers of metallic core material 2 and layers of wear resistant material 3. This may be achieved by first lying down a sheet or strip of metallic material, e.g. steel and then arranging a layer of wear resistant material 3, such as MMC, on top of the steel sheet. The wear resistant material may be a slurry of wear resistant powder material and a binder. It may also be in the form of a sheet, such as metallic strip or tape cast material. Further sheets of steel and further layers of wear resistant material are alternating laid on top of each other until a stack of layers is achieved which constitute the complete impeller vane structure.

According to a second alternative, the stack of alternating layers of metallic core material and wear resistant material is achieved by placing sheets of the metallic core material in upright position at predetermined distances from each other. The spaces between the sheets are subsequently filled with a slurry of wear resistant powder material and a binder or filled with a powder of wear resistant material.

The layers that are stacked could have been preformed into a suitable shape for an impeller vane prior to stacking. In other case, the stack of alternating layers is formed into an impeller vane preform by cutting and bending the stack, e.g. by use of pressing tools, into the form of the impeller vane.

The impeller vane preform is thereafter placed in a heatable pressure chamber, normally referred to as a High Isostatic Pressure-chamber (HIP-chamber). The heating chamber is pressurized with gas, typically argon which is pumped into the chamber to an isostatic pressure in excess of 500 bar. The chamber is heated to a temperature below the melting point of the metallic materials in the impeller vane preform, e.g. 50-500° C. below the melting point of the material with the lowest melting point or any phase that can form by a reaction between the materials in the impeller vane. Typically, the impeller vane preform is heated for a period of 1-3 hours depending on the materials used and the size of the impeller vane.

Due to the elevated pressure and temperature, the layers of metallic core material 2 and the layers of wear resistant material 3 deform plastically and bond metallurgically through various diffusion processes into a dense, coherent article. In metallurgic bonding, metallic surfaces bond together flawlessly with an interface that is free of defects such as oxides, inclusions or other contaminants. Two metallic elements that are bound together metallurgically will therefore form an integral body.

After “HIP-ing”, the finished impeller vane may be attached to preformed impeller discs so that a functional impeller is achieved. It is possible to attach the impeller vane releasable to the impeller discs, for example with screws, so that the impeller vane can be replaced when worn out.

According to a second alternative, the impeller vane preform is placed in a capsule of mild steel. The capsule have been designed so that it its contour defines the form of the impeller discs. The capsule is filled with metallic powder, such as steel powder, and is thereafter subjected to HIP as described above. During HIP, the metal powder particles bond metallurgically and form the impeller discs, the layers of metallic core material and wear resistant material bond metallurgically to form the impeller vane and the impeller discs and the impeller vanes bond metallurgically so that a functional impeller is achieved.

According to a third alternative, one or several impeller vane preforms are attached to preformed impeller discs, typically made of steel e.g. by casting or machining. The impeller discs may for example comprise slots for accommodating the side surfaces of the impeller vane. The arrangement of impeller discs and preformed impeller vanes are thereafter subjected to HIP as described above so that the layers of metallic core material 2 and the layers of wear resistant material 3 in the impeller vane bond metallurgical to each other and to the impeller discs. The metallurgical bond between impeller vanes and impeller discs provides for a very strong impeller.

1. An impeller vane comprising:
a leading edge and a trailing edge:
at least a first metallic core material;
at least a first wear resistant material, wherein a hardness of said at least first wear resistant material exceeds a hardness of said at least first metallic core material;
a plurality of layers of said at least first metallic core material; and
a plurality of layers of said at least first wear resistant material, wherein said plurality of layers of the at least first metallic core and wear resistant material extend from the leading edge to the trailing edge of the impeller vane and are arranged alternatingly throughout the cross section of the impeller vane.

2. The impeller vane according to claim 1, wherein the plurality of layers of said at least first metallic core material have a thickness of 5 mm or less.

3. The impeller vane according to claim 1, wherein the plurality of layers of said at least first wear resistant material have a thickness of 15 mm or less.

4. The impeller vane according to claim 1, wherein said impeller vane consists of at least 5 layers.

5. The impeller vane according to claim 4, further comprising layers of further metallic core materials and/or layers of further wear resistant materials.

6. The impeller vane according to claim 1, wherein said at least first metallic core material is selected from the group consisting of nickel-base alloys, low carbon cobalt-base alloys and iron-base alloys.

7. The impeller vane according to claim 1, wherein said at least first wear resistant material is selected from the group consisting of cemented carbide, high carbon cobalt-base alloys and metal matrix composite.

8. An impeller comprising at least one impeller vane having a leading edge; a trailing edge; at least a first metallic core material; at least a first wear resistant material, a hardness of said at least first wear resistant material exceeding a hardness of said at least first metallic core material; a plurality of layers of said at least first metallic core material; and a plurality of layers of said at least first wear resistant material, wherein said plurality of layers of the at least first metallic core and wear resistant material extend from the leading edge to the trailing edge of the impeller vane and are arranged alternatingly throughout the cross section of the impeller vane.

9. A method for manufacturing an impeller vane having a plurality of layers of at least a first metallic material and at least a first wear resistant material, the method comprising the steps of:
alternatingly arranging a plurality of layers of at least a first metallic material and a-at least a first wear resistant material;
forming said plurality of layers to an impeller vane preform;
subjecting said impeller vane preform to a high isostatic pressure process for a predetermined time at a predetermined pressure and predetermined temperature so that the layers of said at least first metallic material and said at least first wear resistant material bond metallurgically to obtain the impeller vane.

10. A method for manufacturing an impeller including an impeller vane having a plurality of layers of at least a first metallic core material and at least a first wear resistant material, said method comprising the steps of:
alternatingly arranging the plurality of layers of the at least a first metallic core material and the at least first wear resistant material;
forming said layers to at least one impeller vane preform;
providing a front impeller disc and a rear impeller disc; and
metallurgically bonding, in a high isostatic pressure process, the layers of said at least first metallic core material and said at first wear resistant material of said at least one impeller vane preform to each other and to the front impeller disc and rear impeller disc, wherein the impeller is obtained.

11. The method according to claim 10, wherein the front impeller disc and the rear impeller disc are pre-manufactured.

12. The method according to claim 10, comprising the steps of:
arranging said at least one impeller vane preform in a capsule that defines a shape of the front impeller disc and the rear impeller disc;
filling said capsule with metallic powder;
metallurgically bonding, in a high isostatic pressure process, said metallic powder in the capsule into the impeller front disc and the impeller rear disc; and
simultaneously metallurgically bonding said first metallic core material and said first wear resistant material of said at least one impeller vane preform to each other and to the front impeller disc and a rear impeller disc.
